(19) United States
(12) Patent Application Publication
(10) Pub. No.: US 2019/0056689 A1
(43) Pub. Date: Feb. 21, 2019

(54) SYSTEM AND METHOD FOR PRINTING WITH DEPLETING TONER OR INK LEVELS

(71) Applicants: Kabushiki Kaisha Toshiba, Minato-ku (JP); Toshiba TEC Kabushiki Kaisha, Shinagawa-ku (JP)

(72) Inventors: Nick CHOU, Lake Forest, CA (US); Allen MA, Irvine, CA (US); Dehua ZHAO, Irvine, CA (US)

(21) Appl. No.: 15/681,052

(22) Filed: Aug. 18, 2017

(51) Int. Cl. G03G 15/00; G03G 15/08

(52) U.S. Cl. CPC G03G 15/556; G03G 15/0856; G03G 15/0831

(57) ABSTRACT

A system and method for selective printing of documents in low toner or ink situations includes a processor, a memory and an input configured for receiving an electronic print job. A current level of toner or ink is measured and this information, together with data specifying an amount of toner or ink needed to render printed images and information from the print job itself, is used to calculate toner or ink required to complete a printing of the print job. The processor generates a user prompt when there is an insufficient amount of toner or ink to complete the printing of the print job.

### TECHNICAL FIELD

This application relates generally to document printing with depleting levels of toner or ink. The application relates more particularly to multifunction peripherals that can determine if there is sufficient toner or ink to complete an incoming print job and to give an associated user a choice to abort or print when one or more ink or toner levels will be exhausted before the print job can be fully completed.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Given the expense in obtaining and maintain MFPs, devices are frequently shared or monitored by users or technicians via a data network. MFPs, while moveable, are generally maintained in a fixed location. Until more recent times, users, which may include individuals or groups such as employees, administrators or technicians administrators of networked MFPs, were also generally in relatively fixed location. A user would typically communicate documents or other information from his or her office or workstation. An administrator or technician would also monitor devices from a workstation.

Printers, including MFPs with print capability, rely on replenish-able consumables, including paper, ink or toner. If a device is out of paper, printing is not possible until new paper is loaded. When a toner or ink level is low, printing may still be possible. Devices frequently signal when a toner cartridge or ink cartridge is low, alerting a user or administrator to replenish a supply. Printing may still be possible with low toner levels. Replacing a cartridge immediately upon receipt of a low level signal can result in wasted toner or ink, and unnecessary user or owner expense. Printing too much from a depleted cartridge can cause lightening of images as levels decrease toward empty. In multicolor printing systems, color is typically generated by adding different colors of toner or ink. By of further example, a color printer may have four toner cartridges comprising additive primary colors of (C)yan, (Y)ellow, (M)agenta, and blac(K), or CYMK. Printing may still be possible when one, two or even three color cartridges are empty, but with a corresponding loss of image color or integrity.

Users may send document processing jobs, such as a print request, to one or more networked devices. In a typical shared device setting, one or more workstations are connected via a network. When a user wants to print a document, an electronic copy of that document is sent to a document processing device via the network. The user may select a particular device when several are available. The user then walks to the selected device and picks up their job or waits for the printed document to be output. If multiple users send their requests to the same device, the jobs are queued and outputted sequentially. Users can be frustrated and their time wasted if they send a print job to a device only to find that only a portion of their job was not printed, or not printed correctly, due to exhaustion of one or more cartridges. A print attempt may result in discarding of some or all of output pages generating wasted cost. Empty cartridges would need to be refilled or replaced, and the user would need to return to their workstation and resend the job.

### SUMMARY

In accordance with an example embodiment of the subject application, a system and method for selective printing of documents in low toner or ink situations includes processor, memory and an input configured for receiving an electronic print job. A current level of toner or ink is measured and this information, together with data specifying an amount of toner or ink needed to render printed images and information from the print job itself is used to calculate toner or ink required to complete a printing of the print job. The processor generates a user prompt when there is an insufficient amount of toner or ink to complete the printing of the print job.

### BRIEF DESCRIPTION OF THE DRAWINGS

Various embodiments will become better understood with regard to the following description, appended claims and accompanying drawings wherein:

FIG. 1 an example embodiment of a document rendering system that facilitates selected full or partial printing based on remaining toner or ink levels;

FIG. 2 is an example embodiment of a system that facilitates selected full or partial printing based on remaining toner or ink levels calculated outside of a document rendering device;

FIG. 3 is an example embodiment of a functional device components of a multifunctional peripheral;

FIG. 4 is an example embodiment of calculation of deposition area for text images;

FIG. 5 is an example embodiment of calculation of deposition area for graphical or raster images; and

FIG. 6 is a flowchart an example embodiment of a system for selective printing of a print job in accordance with mid-job toner or ink depletion.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In accordance with example embodiments herein, an electronic print job is tested against the amount of toner or ink that will be required to complete the job and an amount of toner or ink remaining in a printing device relative to that amount. A user may be prompted to decide whether to complete or abort their print request when only a portion of their job will be printed before a cartridge is empty. This prevents lost time and wasted paper and lessens user frustration. A user may decide to abort a job and send it to another device for printing instead. A user may decide to continue the printout despite an empty cartridge. For example, a user may be satisfied if embedded color images are not rendered accurately due to a loss of a primary color cartridge since they are only interested in proofing a document's black-and-white text. A user may choose to print only those pages that can be print before a cartridge is emptied. For example, the originally selected printer may be faster or have better imaging properties, and the user can get a large portion of their document printed and then sent the remaining print job to a slower or less capable device.

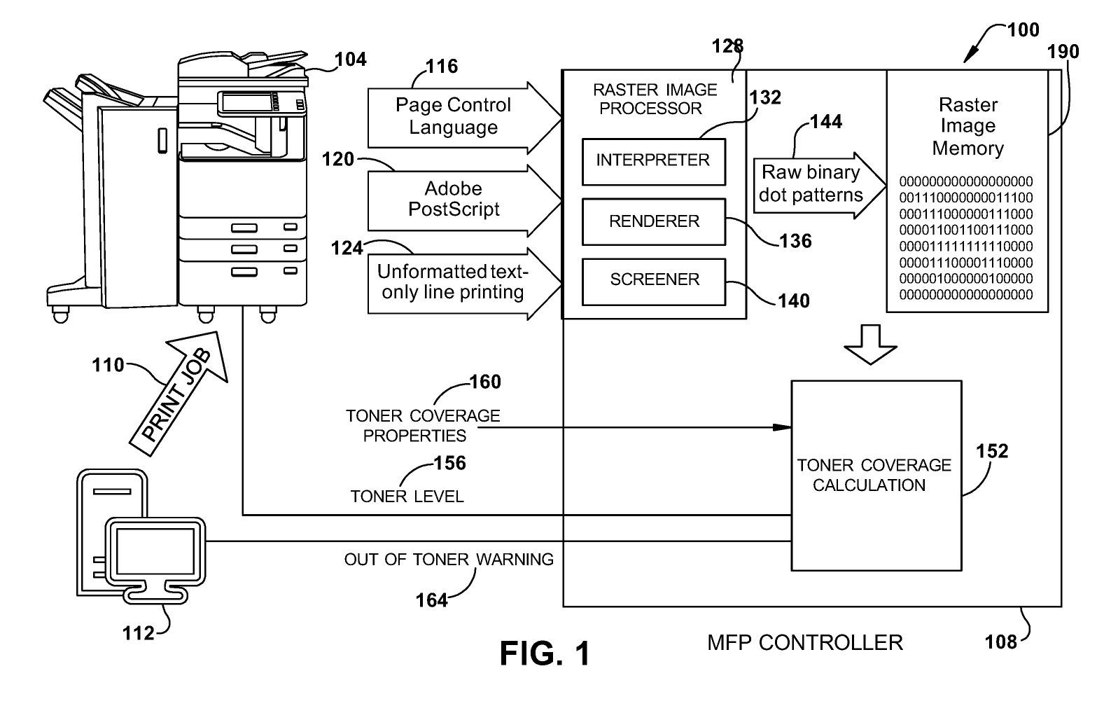

In accordance with the subject application, FIG. 1 illustrates an example embodiment of a document rendering system 100 that facilitates selected full or partial printing of jobs for which one or more cartridges will be empty before job completion. MFP 104 includes an embedded intelligent controller 108 comprised of a processor and memory as will be detailed below. When a user sends electronic print job 110 to MFP 104 from any suitable device, such as workstation 112, corresponding print data is received and processed by the controller 108. Print job content may include a page control language. Content may also include page control language 116, a set filetype, such as an ADOBE POSTSCRIPT 120 or a portable document format (PDF) content, or unformatted text 124. Data may also include embedded images. A raster image processor (RIP) 128, suitably accomplished by controller 108, can take these, or any suitable format text, vector, bitmap or image file and generate a bitmapped, raster image or RIP file to be printed by implementation of interpreter 132, renderer 136 and screener 140 as will be understood by one of ordinary skill in the art. The resultant RIP file, comprised of raw binary dot patterns 144 results in a raster image in memory 190.

The resultant raster image facilities a toner coverage calculation 152 of whether there is sufficient toner (or ink) to print the complete job file. Calculation is suitably made in conjunction with toner level data 156, suitably supplied by one or more level monitors within MFP 104, along with known toner coverage properties 160, such as how much toner is needed for each image pixel required to render the print job. Toner coverage properties 160 may be specified by the manufacturer, or derived from testing. Toner coverage properties 160 may also take into account paper type, ambient temperature, print engine settings, fuser bar settings, humidity and the like. An out of toner warning 164 is generated which informs the user that there is insufficient toner to complete their print job. An out of toner warning 164 may include a simple yes or no response as to whether the document should be printed nonetheless. An out of toner warning 164 may also include information as to a particular toner color that will be exhausted prior to printing the entire job. Calculation can be made as to what portion of the job can be printed with the remaining toner and provide the user with an option to print that portion, or any suitable portion, of the job.

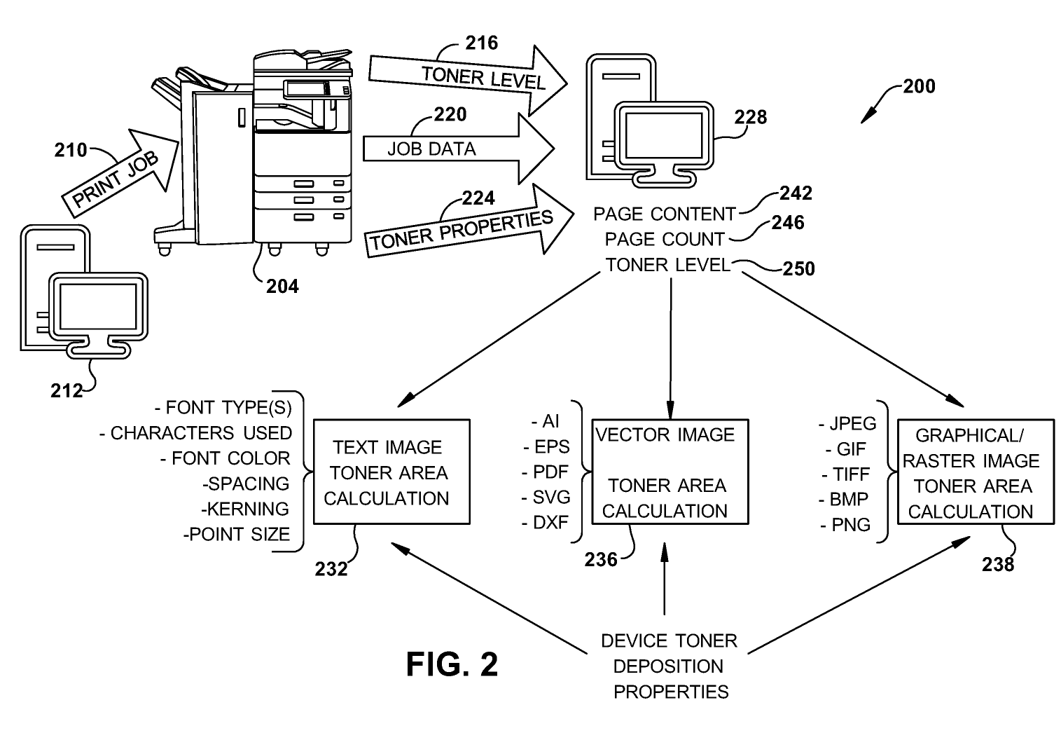

FIG. 1 illustrated an example embodiment wherein tone calculation is accomplished on a printing device itself, such as MFP 104. FIG. 2 illustrates an embodiment of a system 200 that facilitates selected full or partial printing based on remaining toner or ink levels calculated outside of a document rendering device. In the illustrated example, MFP 204 receives a print job 210 from a user via any suitable device, such as workstation 212. The MFP communicates toner level 216, print job data 220 and toner coverage properties 224 to a monitoring server 228. In one example embodiment, server 228 can be provided with a RIP simulator to mirror a raster imaging processing that would occur in a printer or MFP. However, the server would need to have a RIP simulator for each device type or brand making it difficult to supply a server that services toner and job monitoring for many different devices. In that instance, the server 228 suitably engages one or more sub-processes to calculate remaining toner relative to a print job. These include text image toner area calculation 232, vector image toner area calculation 236 and graphical or raster image toner area calculation 238, all of which suitably operate in conjunction with page content data 242, page count data 246 and toner level data 250.

Text image toner calculation is suitably made on text inclusive print data, encoded in any suitable format such as ASCII, EBCDIC, ISO 8859, Unicode, JIS or the like. Print job information useful to calculate toner coverage include font type, character set, font color, font spacing, kerning and point size as will be detailed further below. Vector image calculation is suitably made on files such as Adobe Illustrator (AI), encapsulated POSTSCRIPT (EPS), portable document format (PDF), scalable vector graphics (SVG), drawing exchange format (DXF), or the like. Graphical, raster or bitmapped calculation at sub-process 338 is suitably used on print content, such filetypes including Joint Photographic Experts Group (JPEG), Graphical Image Format (GIF), tagged information file format (TIFF), bitmap (BMP), Portable Network Graphics (PNG), or the like.

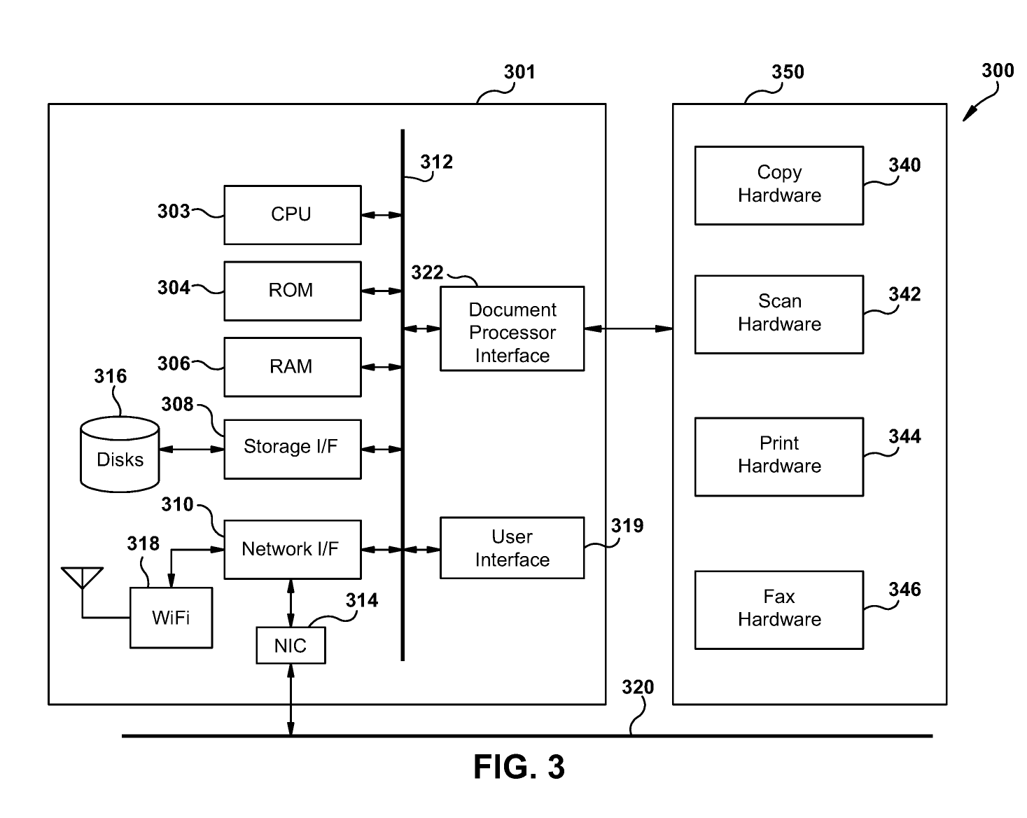

Turning now to FIG. 3, illustrated are functional device components 300 suitably comprising a multifunctional peripheral such as MFP 104 of FIG. 1 and MFP 204 of FIG. 2. Included is controller 301 comprised of one or more processors, such as that illustrated by processor 302. Each processor is suitably associated with non-volatile memory such as ROM 304, and random access memory (RAM) 306, via a data bus 312.

Processor 302 is also in data communication with a storage interface 308 for reading or writing to a storage 316, suitably comprised of a hard disk, optical disk, solid-state disk, cloud-based storage, or any other suitable data storage as will be appreciated by one of ordinary skill in the art.

Processor 302 is also in data communication with a network interface 310 which provides an interface to a network interface controller (NIC) 314, which in turn provides a data path to any suitable wired or physical network connection 320, or to a wireless data connection via wireless network interface 318. Example wireless connections include cellular, Wi-Fi, Bluetooth, NFC, wireless universal serial bus (wireless USB), satellite, and the like. Example wired interfaces include Ethernet, USB, IEEE 1394 (FireWire), Apple Lightning, telephone line, or the like.

Processor 302 can also be in data communication with any suitable user input/output (I/O) interface 319 which provides data communication with user peripherals, such as displays, keyboards, mice, track balls, touch screens, or the like.

Also in data communication with data bus 312 is a document processor interface 322 suitable for data communication with MFP functional units 350. In the illustrated example, these units include copy hardware 340, scan hardware 342, print hardware 344 and fax hardware 346 which together comprise MFP functional hardware 350. It will be understood that functional units are suitably comprised of intelligent units, including any suitable hardware or software platform.

Hardware monitors suitably provide device event data, working in concert with suitable monitoring systems. By way of further example, monitoring systems may include page counters, sensor output, such as consumable level sensors, temperature sensors, power quality sensors, device error sensors, door open sensors, and the like. Data is suitably stored in one or more device logs, such as in storage 316.

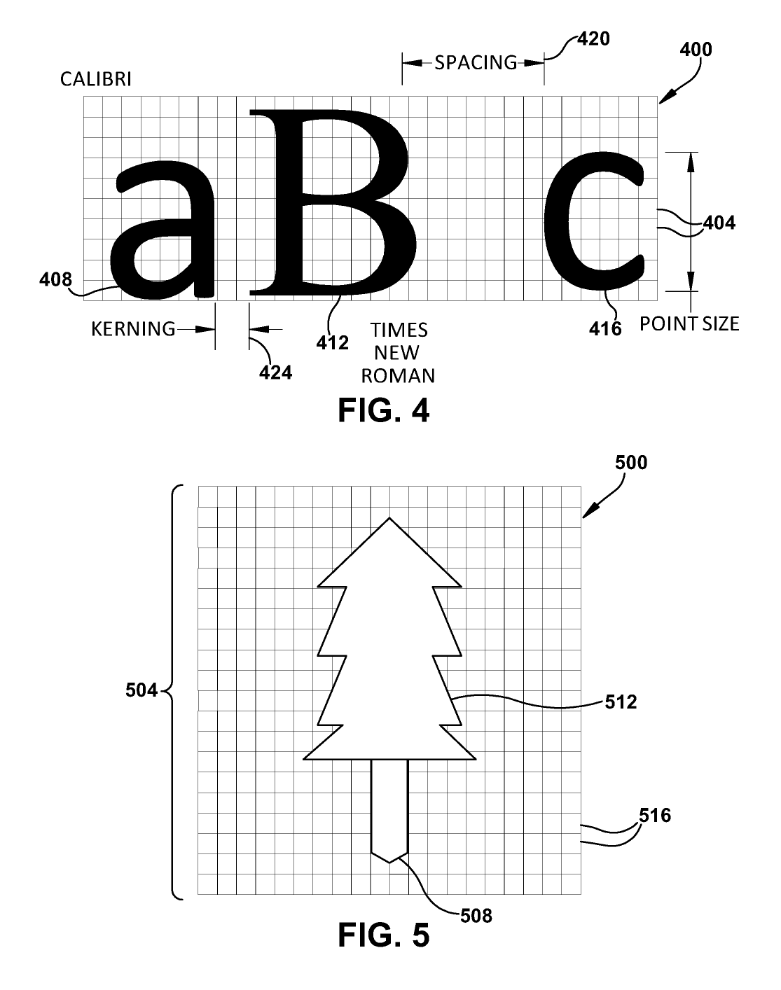

FIG. 4 illustrates an example embodiment of calculating toner deposition area for text images, such as with text image toner area calculation 232 of FIG. 2. Grid 400 is comprised of an array of pixels 404 onto which character data can be superimposed. In the illustration, a pixel 404 can be fully or partially covered by a character, which character can be in any specified type font, such as Calibri lower case “a” 408, Times New Roman capital “B” 412, or Calibri lower case “c” 416. It will be understood that the larger the font, e.g., a larger point size, more toner area will be required. Also influencing toner area is character spacing 420, which spacing may be altered depending on adjoining characters by kerning 424. A finer grid facilitates more precise toner area calculation at a cost of added processing power requirements. Vector image calculation is suitably accomplished by calculating a vector and overlaying it over a grid analogously to that of FIG. 4.

FIG. 5 illustrates an example embodiment of graphical or raster image calculation such as with sub-process 238 of FIG. 2. In this instance, an image of a tree 504, comprised of a brown trunk portion 508 and a green branch portion 512 that are superimposed on pixels 516 of the grid 500. In this instance a pixel 516 can be blank, fully or partially covered by a toner of a single color, or fully or partially covered by toner of multiple colors. Such pixel coverage facilitates toner required for multiple toner types needed for color printing.

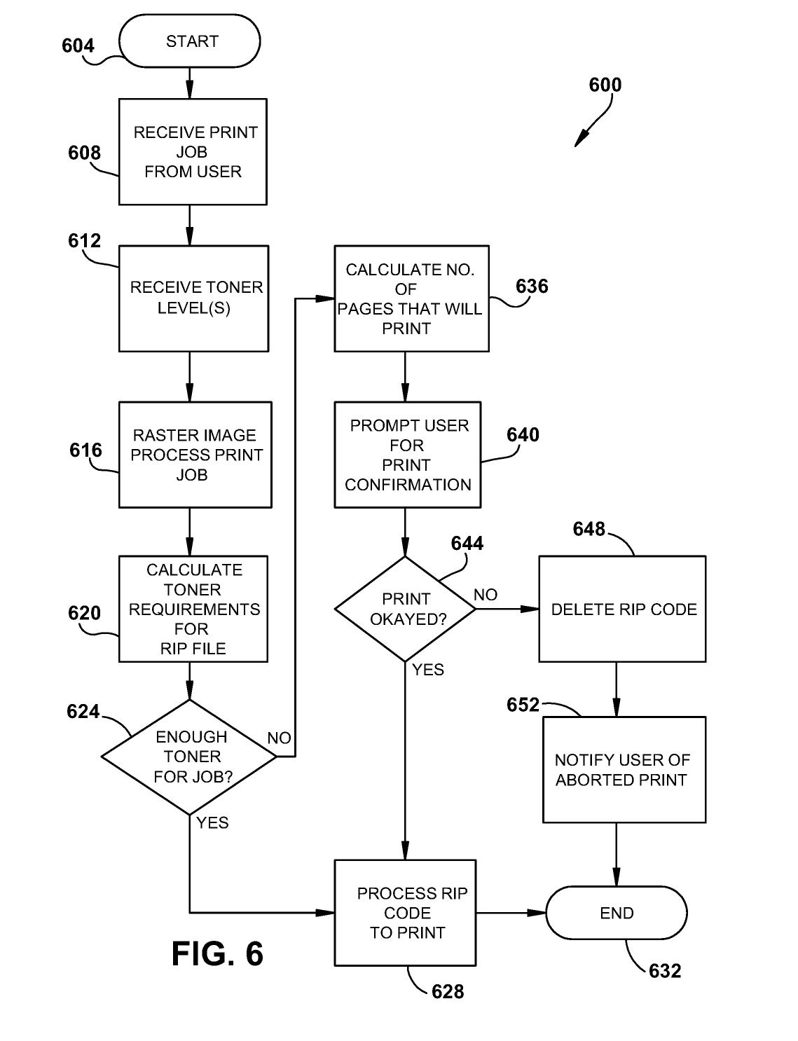

FIG. 6 is an example embodiment of a flowchart 600 for selective printing of a print job in accordance with mid-job toner or ink depletion. The process commences at block 604. A printer, such as MFP 104 of FIG. 1, receives a print job from a user at block 608, and toner level information at block 612. The MFP controller generates a RIP image at block 616 and calculates associated toner requirements at block 620. If a determination is made at block 624 that there is sufficient toner to complete the entire job, the RIP code is processed at block 628 and the print job ends at block 632.

If a determination is made at block 624 that there is not enough toner to complete the entire job, then the number of pages that can be successfully printed is suitably calculated at block 636. Next, a user prompt is generated at block 640 seeking instructions as whether to print, abort a print, or complete a partial print. Next, if a print or partial print is selected at block 644, the printout is made accordingly at block 620 before the process ends at block 632. If the print is not accepted, in whole or in part, at block 644, the RIP code is no longer needed and can be deleted at block 648. The user is notified of the abort at block 652, after which the process ends at block 632.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A system comprising:
a processor and associated memory;
an input configured to receive an electronic, multicolor print job; and
an input configured to receive level data corresponding to current levels of multiple colors of toner or ink in an associated printer,
wherein the processor is configured to generate raster image data corresponding to a bitmapped rendering of a received electronic print job,
wherein the memory is configured to store relationship data corresponding to an amount of toner or ink needed to render printed, multicolor images calculated in accordance with pixel data associated with generated raster image data,
wherein the processor is configured to calculate toner or ink required to complete a printing of the print job in accordance with the electronic print job, the relationship data and the level data, and
wherein the processor is further configured to generate a user prompt when the processor calculates an insufficient amount of one or more colors of toner or ink to complete accurate printing of all pages of the print job,
wherein the processor is further configured to generate the user prompt including a user selectable option to print all pages of the print job notwithstanding an insufficient amount of one or more colors of toner or ink; and
wherein the processor is further configured to print all pages of the print job in accordance with user input received responsive to the user prompt.

2. The system of claim 1 wherein the processor is further configured to generate an electronic raster image of the electronic print job to calculate the toner or ink required to complete the printing of the print job in accordance with the level data.

3. (canceled)

4. The system of claim 1 wherein the processor is further configured to print a portion of the print job for which sufficient toner or ink for printing is calculated.

5. (canceled)

6. (canceled)

7. The system of claim 1 wherein the processor is further configured to render or delete the electronic raster image responsive to the user input.

8. A method comprising:
receiving an electronic print job into a memory;
receiving level data corresponding current levels of multiple colors of toner or ink in an associated printer into the memory;
calculating, via an associated processor, toner or ink required to complete a printing of the print job in accordance with pixel data of raster image data generated in accordance with the electronic print job, the level data and relationship data corresponding to amounts of colored toner or ink needed to render printed images;
generating a user prompt when the processor calculates an insufficient amount of one or more colors of toner or ink to complete the printing of the print job; and
generating the user prompt for selective printing of all pages of the print job notwithstanding an insufficient amount of one or more colors of toner or ink; and
receiving user input responsive to the user prompt; and
printing all pages of the print job responsive to received user input.

9. The method of claim 8 further comprising generating an electronic raster image of the electronic print job to calculate the toner or ink required to complete the printing of the print job in accordance with the level data.

10. (canceled)

11. The method of claim 8 further comprising printing a portion of the print job for which sufficient toner or ink for printing is calculated.

12. (canceled)

13. (canceled)

14. The method of claim 8 further comprising deleting the electronic raster image responsive to the user input.

15. A multifunction peripheral comprising:
an intelligent controller including a processor and associated memory;
a toner cartridge;
a print engine;
a toner level sensor configured to generate toner level data corresponding to toner levels in a plurality of toner catridge, each toner catridge associated with a unique color; and
a network interface configured to receive an electronic print job,
wherein the controller is configured to generate a raster image file from a received electronic print job,
wherein the controller is further configured to calculate whether there is sufficient toner to accurately print all pages the print job in accordance with toner level data, pixel data of a generated raster image file and toner coverage data indicative of an amount of toner required for printed image pixels,
wherein the controller is further configured enable the print engine to print the print job when a sufficient toner level to print the print job is calculated,
wherein the controller is further configured to generate a user prompt when an insufficient toner level to accurately print all pages of the print job is calculated; and
wherein the controller is farther configured to print all pages of the print job notwithstanding an insufficient toner level in accordance with user input received responsive to the user prompt.

16. (canceled)

17. (canceled)

18. The multifunction peripheral of claim 15 wherein the controller is further configured to generate a user prompt indicative of an accurately printable portion of the print job calculated in accordance with toner level data, the generated raster image file and toner coverage data.

19. The multifunction peripheral of claim 17 wherein the controller is further configured to selectively communicate the raster image file to the print engine in accordance with the user input.

20. (canceled)
